(19) United States
(12) Patent Application Publication
(10) Pub. No.: US 2021/0133907 A1
(43) Pub. Date: May 6, 2021

(54) VALET PARKING SYSTEM

(71) Applicant: Omar Essudan, Atlanta, GA (US)

(72) Inventor: Omar Essudan, Atlanta, GA (US)

(21) Appl. No.: 16/670,384

(22) Filed: Oct. 31, 2019

(51) Int. Cl. G06Q 50/30; G01C 21/36; G07B 15/02

(52) U.S. Cl. CPC G06Q 50/30; G07B 15/02; G01C 21/3685

(57) ABSTRACT

An online airport curbside parking system enabling use of cost-effective off-site parking facilities is provided. The online tool embodied in the present invention enables users to pinpoint the time and place of the valet, while leveraging the online itinerary and flight status of the traveler's related return flights so that far-afield, less expensive offsite parking locations can be utilized to have the valet deliver the valeted vehicle punctually for the returning traveler.

### BACKGROUND OF THE INVENTION

The present invention relates to valet parking systems and, more particularly, to a curbside airport valet system embodied in an online tool for enabling the user of off-site parking.

‘Supply and Demand’ is a bedrock rule in economics for determining the price of anything. The lack of parking at the airport drives related pricing higher than the flight paths. Additionally, such parking is incredibly far from the terminals, which poses a physical challenge as most airline travelers are lugging one or more piece of luggage and are in a hurry.

Theoretically, airport valet parking operations would involve a lot of red tape, approvals needed by the airport for additional individuals along the curbside, as well as a large area of on-site to maintain parking spaces reserved for valet parking. As a result, such would-be airport valet parking operations are restricted by the airport's facilities and bureaucracy, which in turn imposes limitations because of the lack of extra on-site parking spaces, curbside space for ingress and egress, valet booth space and the like that to-date have prevented successful implementation of airport curbside valet parking systems.

As can be seen, there is a need for a curbside airport valet system embodied in an online tool enabling users to make appointments to valet park their cars from the airport curbside, wherein the parking includes offsite parking space that users do not need to traverse. Once the customer checks in by text message or engaging a software application, the present invention provides valets to assist the customers with their luggage and give them a valet ticket for when they return—then the valet parks the users' vehicles at the airports on-site parking or uses off-site parking facilities to increase supply, and thus decrease cost of airport parking.

Airport valet reservations embodied in the systemic online tool and/or platform (software application or website) controls the flow of cars by limiting customer and increases the parking inventory by using parking spaces off-site and/or at other airport parking facilities. The present invention also enables valets to meet customers curbside anywhere, allowing passengers in a hurry to get as close to their terminal as possible. In short, the present invention enables advance airport valet reservations allowing passengers to drop-off and pick-up their vehicles anywhere at airport terminals without being confined to a designated valet area, making airport valet possible at any airport, even airports without the infrastructure to provide valet parking.

### SUMMARY OF THE INVENTION

In one aspect of the present invention, an online airport curbside parking system enabling use of cost-effective off-site parking facilities includes the following:

computer-implementing a flight schedule of a traveler so as to create an intersection in time of said traveler and a valet driving a vehicle of the traveler at a predetermined return location based in part on a flight status of a returning flight of said flight schedule and an off-site parking location; a predetermined departure location on the flight status of a prior departure flight of said flight schedule, wherein the valet subsequently drives said vehicle to the off-site parking location after providing a claim ticket to the traveler, wherein the predetermined departure and return locations are curbside at an airport associated with said flight schedule, and wherein the flight status of the returning flight is provided electronically by an airline associated with the returning flight.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention from a user's viewpoint;

FIG. 2 is a diagrammatic view of an exemplary embodiment of the present invention, demonstrating pricing functionality 20;

FIG. 3 is a diagrammatic view of an exemplary embodiment of the present invention, demonstrating scheduling functionality 22; and

FIG. 4 is a schematic flowchart view 24 of an exemplary embodiment of the present invention from a valet's viewpoint.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an online airport curbside parking system enabling use of cost-effective off-site parking facilities. The online tool embodied in the present invention enables users to pinpoint the time and place of the valet, while leveraging the online itinerary and flight status of the traveler's related flights. The inherently computer-based technology of Internet flight status updates is enhanced by being operatively associated with the online tool of the present invention so that far-afield offsite parking locations can be utilized to have the valet deliver the valeted vehicle punctually for the returning traveler.

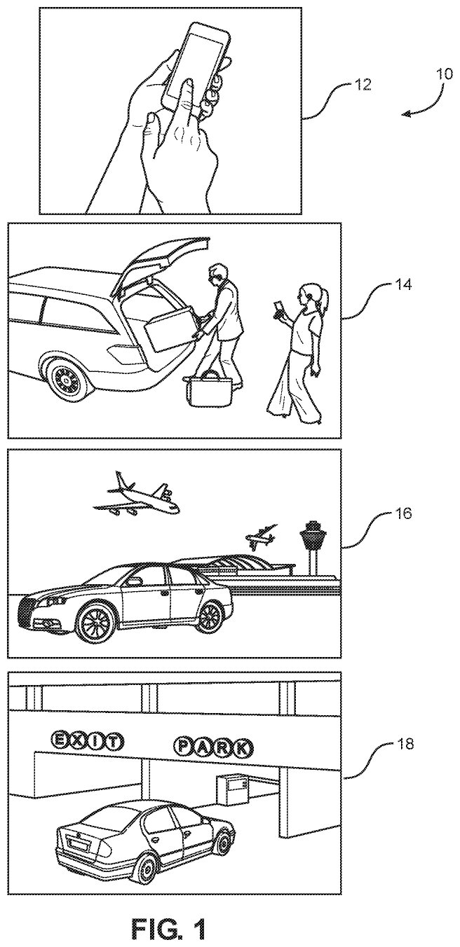

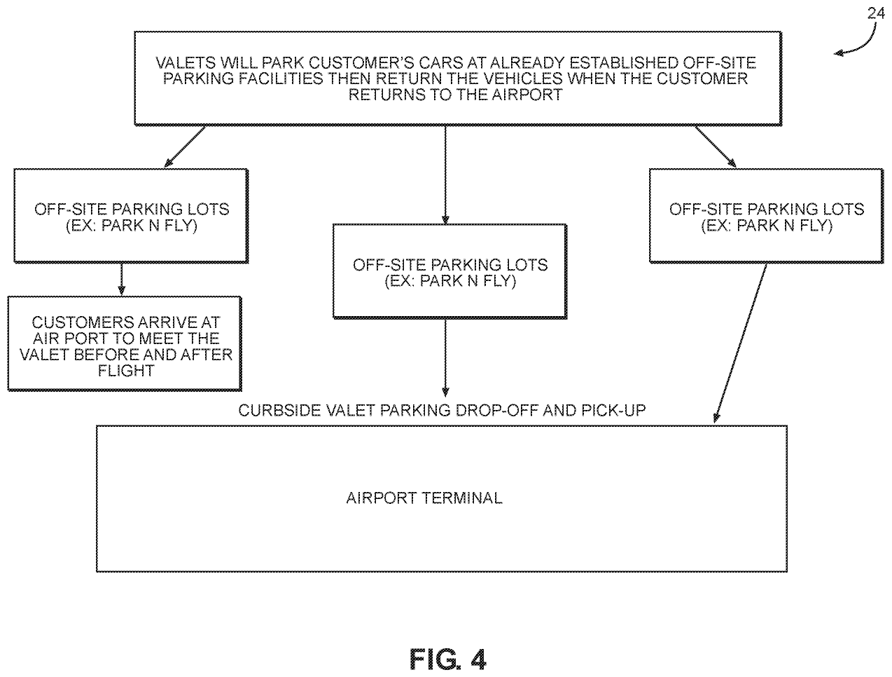

Referring to FIGS. 1 through 4, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

A systemic process 10 for enabling airport valet services may include the following. In a first step 12, including a customer using the online tool to make a reservation to meet a valet at a specific curbside location at an airport at an appointed date and time, wherein the customer communicates with a valet associated with said reservation, most likely by way of a designated contact number, at a predetermined time (for instance, 15 minutes before the scheduled reservation time) so that the valet can get the customers vehicle information.

In the next step 14, the associated valet may meet and greet the customer curbside, give the customer a claim ticket and help with any baggage—the customer enters the terminal to depart.

In subsequent steps 16 and 18, the valet will drive off with the customers vehicle to a parking space (on or off-site) until the customer returns. Based on a communicated itinerary, when the customer's returning plane lands the present invention will notify the associated valet or suitable replacement within a suitable amount of time based in part on the estimated time of arrival of the itinerary (and online flight status updates) and the known parking location, possibly at an off-site facility that could be more than twenty miles away, and a lot more affordable to the user and purveyors of the present invention.

For instance, when a customer lands after their returning flight they will notify the valet they're ready for an agreed-upon pick-up time and location (possibly after the valet has already started to drive the customer's vehicle back to the vehicle as disclosed in steps 16 and 18), and the valet will return the customer's vehicle to the customer curbside, meet and greet the customer and help them with any baggage. The customer leaves the airport and they're on their way.

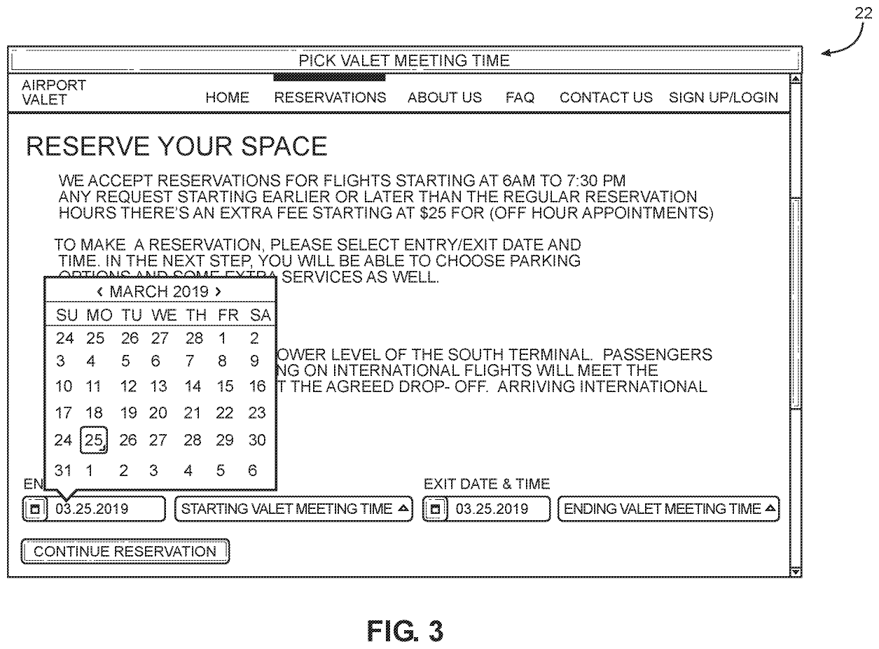

By utilizing a website or software application embodied in the systemic platform, the valet reservations are made by customers by entering their flight itinerary, as illustrated in FIG. 3.

Valet attendants may park the customers vehicle at off-site airport parking lots owned by other parking companies, allowing the service to have a large choice of inventory at any off-site parking facilities or hotel parking lots that would not otherwise be available to users or even other airport-sponsored valet parking systems.

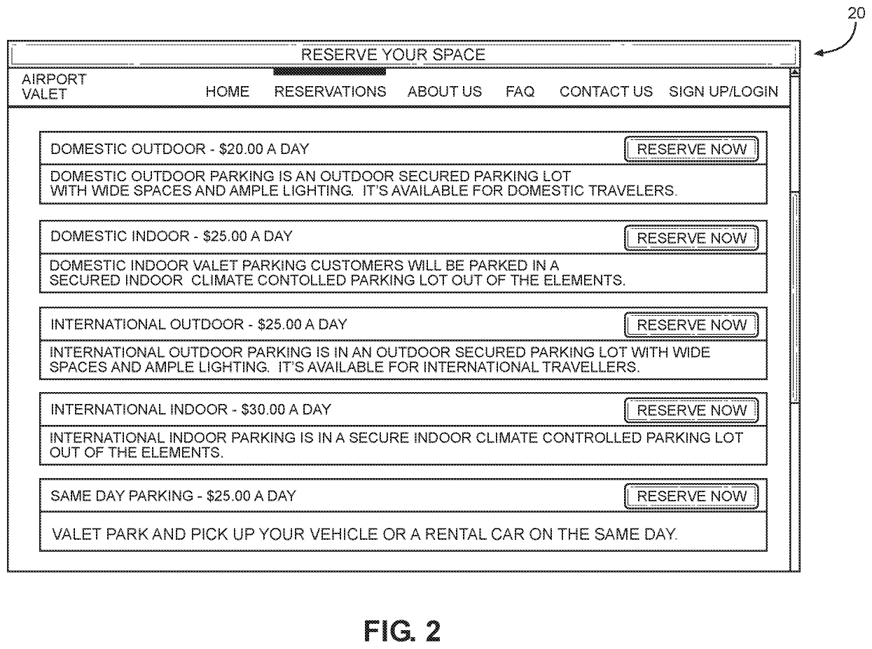

The systemic platform may have features like flight times and airport parking status, as well as booking and scheduling functionality (as illustrated in FIGS. 2 and 3, respectively) and forms for the customer's itinerary. A geo-locator (e.g., GPS or the like) may be utilized for the valet and the customer to see what location they will meet. A payment gateway for online payments may also be provided.

The bottom line is that airline passengers can drive to the terminal curb and valet their vehicles right from there without driving around looking for expensive parking at the airport in far-away parking decks—saving precious time. Disabled and elderly customers, customers with children, and customers with unwieldly amounts of luggage can use the convenience of being dropped at the curbside. The present invention also tilts the Supply and Demand rule in the favor of the user as opposed to the airports.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. An online airport curbside parking system enabling use of cost-effective off-site parking facilities, comprising:
computer-implementing a flight schedule of a traveler so as to create an intersection in time of said traveler and a valet driving a vehicle of the traveler at a predetermined return location based in part on a flight status of a returning flight of said flight schedule and an off-site parking location.

2. The online airport curbside parking system enabling use of cost-effective off-site parking facilities of claim 1, further comprising:
a predetermined departure location on the flight status of a prior departure flight of said flight schedule, wherein the valet subsequently drives said vehicle to the off-site parking location.

3. The online airport curbside parking system enabling use of cost-effective off-site parking facilities of claim 2, further comprising:
a claim ticket being given to the traveler at the predetermined departure location.

4. The online airport curbside parking system enabling use of cost-effective off-site parking facilities of claim 2, wherein the predetermined departure and return locations are curbside at an airport associated with said flight schedule.

5. The online airport curbside parking system enabling use of cost-effective off-site parking facilities of claim 1, wherein the flight status of the returning flight is provided electronically by an airline associated with the returning flight.
